(19) United States
(12) Patent Application Publication
(10) Pub. No.: US 2003/0087220 A1
(43) Pub. Date: May 8, 2003

(54) Apparatus, method, and software management system to enhance athletic performance

(76) Inventor: Robert C. Bessette, Tucson, AZ (US)

Correspondence Address: Dale F. Regelman, Law Office of Dale F. Regelman, P.C., 4231 S. Fremont Avenue, Tucson, AZ, 85714, US

(21) Appl. No.: 10/288,748

(22) Filed: Nov. 6, 2002

Related U.S. Application Data
(60) Provisional application No. 60/332,981, filed on Nov. 6, 2001.

(51) Int. Cl. G09B 9/00; G09B 19/00; A63B 69/00

(52) U.S. Cl. 434/247

(57) ABSTRACT

A method to enhance athletic performance. The method designates a performance course, sets an ultimate performance time for that designated performance course, and ascertains the actual performance time for an athlete to negotiate that designated performance course. The method then establishes an incremental performance time for the athlete, where that incremental performance time is about one percent faster than the athlete's current actual performance time. The method then positions (N) data stations along the designated performance course and calculates, based upon said incremental performance time and the location of each data station along said designated performance course, the (j)th calculated time comprising the time the athlete should pass the (j)th data station. As the athlete negotiates the performance course, the method flashes the (j)th data station at a time equal to t0 plus said (j)th calculated time, measures the (j)th actual time, and displays the difference between the (j)th calculated time and the (j)th actual time.

### FIELD OF THE INVENTION

The present invention relates to an apparatus, method, and performance enhancement management system to enhance athletic performance.

### BACKGROUND OF THE INVENTION

A wide variety of devices have been employed in developing programs for athletes and health enthusiasts. Coaches have employed a different variety of devices in sports, such as track events. Still different approaches have been employed for attempting to predict the winner in athletic contests. None of the prior art apparatus has enabled the doctor, coach, or the participant to set a desired performance level, and train the participant up to that desired performance level, while affording a real-time analysis of the athlete's performance.

Several different approaches have been employed to try to create and heighten spectator interest in track, automobile racing, horse racing, soccer events, and many other sports. For example, announcers have announced times of world records and the like for certain track events before the race begins. With the advent of television our TV monitors have shown the output of elapsed time indicators on the viewers, or spectator's screen. The problem with such apparatus heretofore is that it has not afforded a means of giving real time feedback in a format that to be useful to compare with the relative position of the athlete along the set path the athlete is traversing. Insofar as Applicant is aware, the prior art has not been satisfactory and has not supplied one or more of the desirable features of Applicant's invention, as delineated hereinafter.

What is needed is an apparatus, method, and performance enhancement management system that is adaptable enough to afford a real time feedback in a format useful to the observer for comparing a given athletic performance against a target performance. Whether the observer be a health enthusiast pacing himself around a track based on a doctor-ordered regimen, a soccer athlete traversing a set pattern against his own or a record performance, track athletes running for a predetermined standard, or spectators, either in the stands of a stadium or watching the performances from the sidelines, or on their television screens at home. The apparatus should be settable such that a desired time interval can be entered directly into the apparatus without the use of external timing devices, such as stop watches or the like; and function without direct supervision, once started.

In addition, the apparatus should be able to vary the speed or pace between several rates and be operable in either a continuous mode of operation at a desired pace or be operable in a sequence mode between two or more paces set into the control therefore, including rest periods and repeats. In addition, the apparatus should provide readouts convenient for use by an operator such as, the coach, doctor, or trainer. In addition, the apparatus should be operable to reset the light sequence to a starting point and have the capability of freezing the sequence at any time for any period of time and then resume the set pace or speed from that point in the sequence.

### SUMMARY OF THE INVENTION

Applicant's invention includes a method to enhance athletic performance. Applicant's method first designates a performance course, and sets an ultimate performance time for a first person, i.e. an athlete, to negotiate that designated performance course. In certain embodiments, “negotiate” includes running forward, running backward, dribbling a soccer ball, stick handling a lacrosse ball, stick handling a field hockey ball, stick handling a hockey puck, and the like.

Applicant's method ascertains the current actual performance time, i.e. the (i)th performance time where (i) equals 1, for the first person to negotiate the designated performance course, and establishes the (i+1)th incremental performance time for the first person, where that (i+1)th incremental performance time is about one percent faster than the (i)th actual performance time. In certain embodiments, the (i+1)th incremental performance time is less than about one percent faster than the (i)th actual performance time.

Applicant's method positions (N) data stations along the designated performance course, where each of those (N) data stations includes a light emitting device and/or an audio device, and where each of those (N) data stations is capable of communicating with a system controller, where that system controller is interconnected to a visual display device. Applicant's method further calculates, based upon the (i+1)th incremental performance time and the location of the (j)th data station along the designated performance course, the (j)th calculated time, where that (j)th calculated time comprises the time the first person should pass the (j)th data station, where (j) is greater than or equal to 1 and less than or equal to (N).

The first person begins negotiating the performance course at a time t0. Applicant's method energizes, i.e. flashes, the light emitting device disposed on the (j)th data station at a time equal to t0 plus the (j)th calculated time, and also measures the (j)th actual time, where that (j)th actual time comprises the time the first person actually passes the (j)th data station, and displays on the visual display device a time differential comprising the difference between the (j)th calculated time and the (j)th actual time.

### BRIEF DESCRIPTION OF THE DRAWINGS

The invention will be better understood from a reading of the following detailed description taken in conjunction with the drawings in which like reference designators are used to designate like elements, and in which:

FIG. 1 is a perspective view of Applicant's data station;

FIG. 2 is a block diagram showing the components of Applicant's data station;

FIG. 3 is a block diagram showing the components of Applicant's system controller;

FIG. 4 is a perspective view of a first training course using Applicant's apparatus and method;

FIG. 5 is a perspective view of a second training course using Applicant's apparatus and method;

FIG. 6 is a flowchart summarizing certain steps in Applicant's method;

FIG. 7 is a flowchart summarizing additional steps in Applicant's method;

FIG. 8 is a perspective view of a third training course using Applicant's apparatus and method;

FIG. 9 is a perspective view of a fourth training course using Applicant's apparatus and method; and

FIG. 10 is a perspective view of a fifth training course using Applicant's apparatus and method.

### DETAILED DESCRIPTION OF THE PREFERRED EMBODIMENTS

Applicant's apparatus, method, and performance enhancement management system, provides both an analytical, i.e. objective, tool for the coach, and a subjective, i.e. motivational, tool for the athlete. Using Applicant's apparatus, method, and performance enhancement management system, the coach can select the most efficacious incremental change in workload for the athlete. In addition, the athlete receives real-time incremental performance feedback to perform precisely at the specified workload rather than performing at a higher or lower stress index, i.e. perform faster or slower.

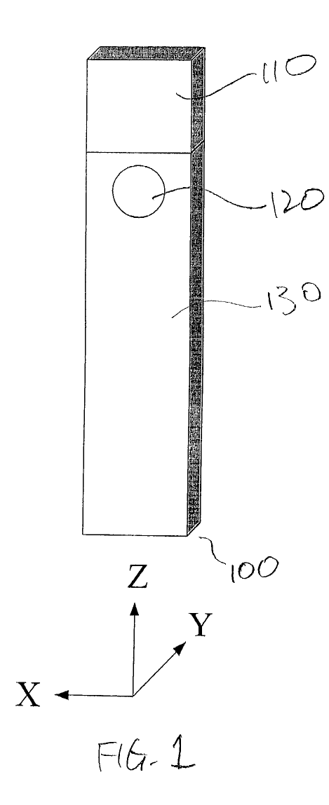

Applicant's invention includes a plurality of individual data stations in two-way wireless communication with a system controller. Referring now to FIG. 1, data station 100 includes visual display device 110 disposed atop assembly 130. Audio device 120 is disposed in assembly 130. In certain embodiments, visual display device 110 includes a xenon strobe light in combination with a fresnel lens. As those skilled in the art will appreciate, a fresnel lens is one that is built to cause fresnel diffraction of the light emitted from visual display device 110. Applicant has found that such a combination of a xenon strobe/fresnel lens enhances visibility in high ambient light conditions, i.e. on a sunny day. It is important that the athlete negotiating a designated performance course not be distracted by attempting to discern a marginally visible light signal.

In certain embodiments, audio device 120 is capable of emitting sounds of any frequency discernable by humans. In certain embodiments, audio device 120 is capable of emitting discernable words and/or phrases.

In the embodiment shown in FIG. 1, visual display device 110 has a roughly rectangular shape. In other embodiments, visual display device 110 has a shape selected from the group comprising a square shape, a cylindrical shape, a spherical shape, and the like. In certain embodiments, visual display device 110 is capable of displaying alphanumeric characters, i.e. text and numbers. In certain embodiments, visual display device 110 is capable of emitting visual light having any color discernable by humans.

Assembly 130 can be formed from any rigid material, including wood, metal, plastic, and combinations thereof. In certain embodiments, data station 100 has a height, i.e. a dimension along the Z axis, of between about 0.1 meters and about 1 meter, a width, i.e. a dimension along the X axis, of between about 0.1 meters and about 0.2 meters, and a depth, i.e. a dimension along the Y axis, of about 0.1 meters and about 0.2 meters.

Data station 100 is dimensioned and constructed such that it can be easily hand-carried. As those skilled in the art will appreciate, data station 100 can be easily transported on a wheeled cart. In certain embodiments, assembly 130 is formed from a cellular material, i.e. a structural foam, in order to minimize its weight. In certain embodiments, data station 100 has a weight less than, or equal to, about 2 kilograms. In alternative embodiments, data station 100 has a weight less than, or equal to, about 1 kilogram.

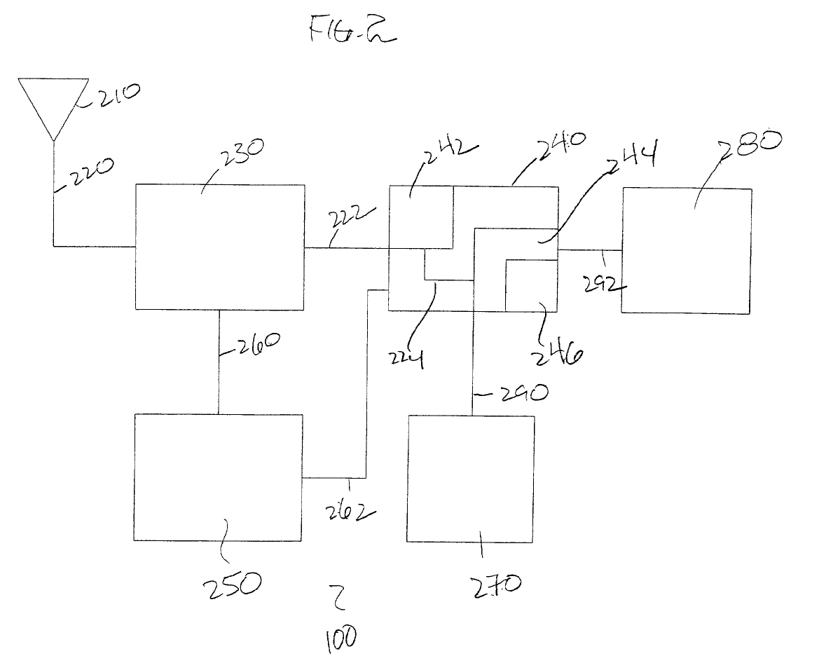

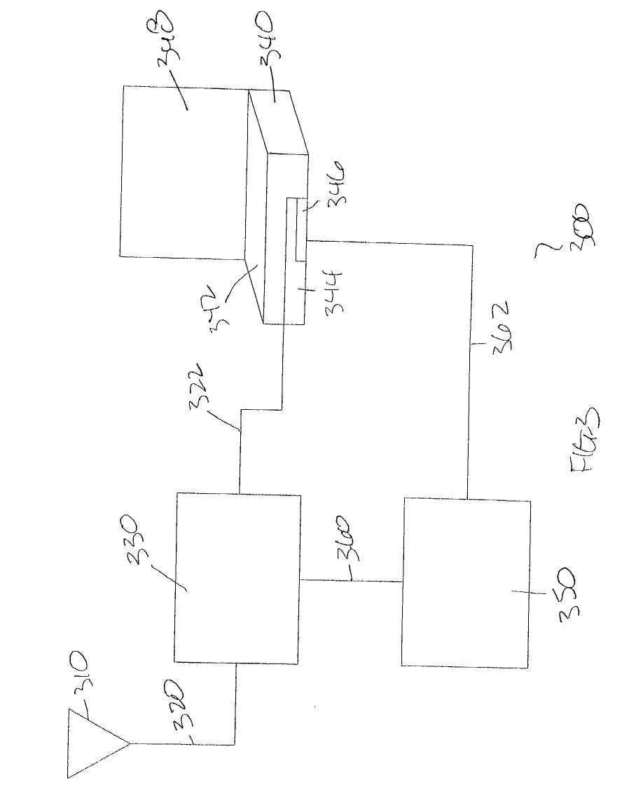

FIG. 2 shows the components of data station 100. Antenna 210 communicates with transceiver 230 via communication link 220. In certain embodiments, antenna 230 is internally disposed within assembly 130 (FIG. 1). In certain embodiments, transceiver 230 is capable of sending and receiving signals having one or more frequencies of between about 10 MHz and about 10 GHz. In certain embodiments, transceiver 230 is capable of sending and receiving signals having frequencies between about 100 MHz and about 1 GHz. In certain embodiments, transceiver 230 provides signals to system controller 300 (FIG. 3) using a first frequency, receives signals from system controller 300 using a second frequency, receives signals from a telemetry device worn by an athlete using a third frequency, and provides signals to telemetry device using a fourth frequency

In certain embodiments the first frequency, the second frequency, the third frequency, and the fourth frequency, are greater than about 1 gigahertz, i.e. microwave signals. Signals using these frequencies may employ a larger “bandwidth” than signals having a lower frequency. As those skilled in the art will appreciate, the available bandwidth of any one signal is governed, at least in part, by licensing restrictions imposed by the Federal Communication Commission.

Increased bandwidth allows the communication of more information between Applicant's portable data stations and the system controller. In addition, use of these microwave frequencies results in less “noise” from other transmissions. By “noise,” Applicant means signals having the same or similar frequencies generated by sources other than Applicant's system. Such other sources include, for example, public service providers, transportation services, paging services, and the like. As those skilled in the art will appreciate, any such “noise” may result in poor data transmission between Applicant's data stations and system controller, and could interfere with the proper sequencing of the light signals emitted by Applicant's data stations.

Transceiver 230 communicates with data station controller 280 via communication link 222. Controller 240 includes microprocessor 242, non-volatile memory 244, and data station operating system 246 stored in memory 244.

Power source 250 provides power to transceiver 230 by power link 260. Power source 250 provides power to controller 240 via power link 262. Controller 280 communicates with, and provides power to, visual display device 280 by communication/power link 292. Controller 240 communicates with, and provides power to, audio device 270 by communication/power link 290. In certain embodiments, power source 250 comprises one or more batteries 252 (not shown in FIG. 2). In certain embodiments, those one or more batteries 252 comprise one or more rechargeable batteries. In certain embodiments, the components of data station 100 are selected such that the station can be powered exclusively using 4 AA batteries. In certain embodiments, data station 100 can be powered using only 4 AA batteries for two (2) hours per day, five (5) days per week, for over one (1) year without replacing those 4 AA batteries.

In certain embodiments, power source 250 comprises one or more solar cells. In certain embodiments those one or more solar cells are disposed on housing 130. In certain embodiments, power source 250 comprises one or more solar cells in combination with one or more rechargeable batteries. In these embodiments, the solar cells provide sufficient electrical energy to operate the data station and sufficient electrical energy to recharge the rechargeable batteries.

FIG. 3 shows the components of system controller 300. System controller 300 includes antenna 310 which communicates with transceiver 330 via communication link 320. In certain embodiments, transceiver 330 is capable of sending and receiving signals having one or more frequencies of between about 10 MHz and about 10 GHz. In certain embodiments, transceiver 330 is capable of sending and receiving signals having frequencies between about 100 MHz and about 1 GHz. In certain embodiments, transceiver 230 receives signals to one or more data stations 100 (FIGS. 1, 2) using a first frequency, provides signals to one or more data stations 100 using a second frequency, receives signals from a telemetry device worn by an athlete using a fifth frequency, and provides signals to telemetry device using a sixth frequency. In certain embodiments, the first frequency, the second frequency, the third frequency, the fourth frequency, the fifth frequency, and the sixth frequency, are greater than about 1 gigahertz.

Power source 350 provides power to transceiver 330 via power link 360. In certain embodiments, power source also provides power to system controller 340 using power link 362. In certain embodiments, power source 350 comprises one or more batteries 352 (not shown in FIG. 3). In certain embodiments, those one or more batteries 352 comprise one or more rechargeable batteries.

In the embodiment shown in FIG. 3, system controller 340 comprises a personal computer. Personal computer 340 includes data input device 342, non-volatile memory 344, and visual display device 348. In other embodiments, system controller 340 comprises a microprocessor in combination with, among other things, visual display device 348, non-volatile memory 344, and software 346 to implement Applicant's method.

Applicants' system controller further includes a data storage device, such as nonvolatile memory 344, comprising a computer useable medium having computer readable program code disposed therein, such as Applicant's performance management program 346, for implementing Applicants' method to enhance athletic performance. Applicants' invention further includes computer program products embodied as program code 346 stored in one or more storage devices 344, such as a magnetic disk, a magnetic tape, or other non-volatile memory device disposed in a system computer 340.

Applicant's invention further includes a method and a performance management system using Applicant's apparatus. Applicant's method makes use of what physiologists refer to as “The General Adaptation Syndrome.” This syndrome posits that athletes can, with minimal stress, adapt to more and more difficult workloads if, the incremental changes are scientifically determined, and if precisely controlled. Using Applicant's apparatus and method such effective incremental performance specifications can be achieved. More specifically, Applicant's apparatus and method provides coaches, for the first time ever, the tools to control precise incremental changes in an individual athlete's workload, as well as the means to measure in real time that athlete's heart rate and recovery curves. Applicant's invention can be used in sports as diverse as soccer, field hockey, ice hockey, track, football, basketball, bicycling, and so on.

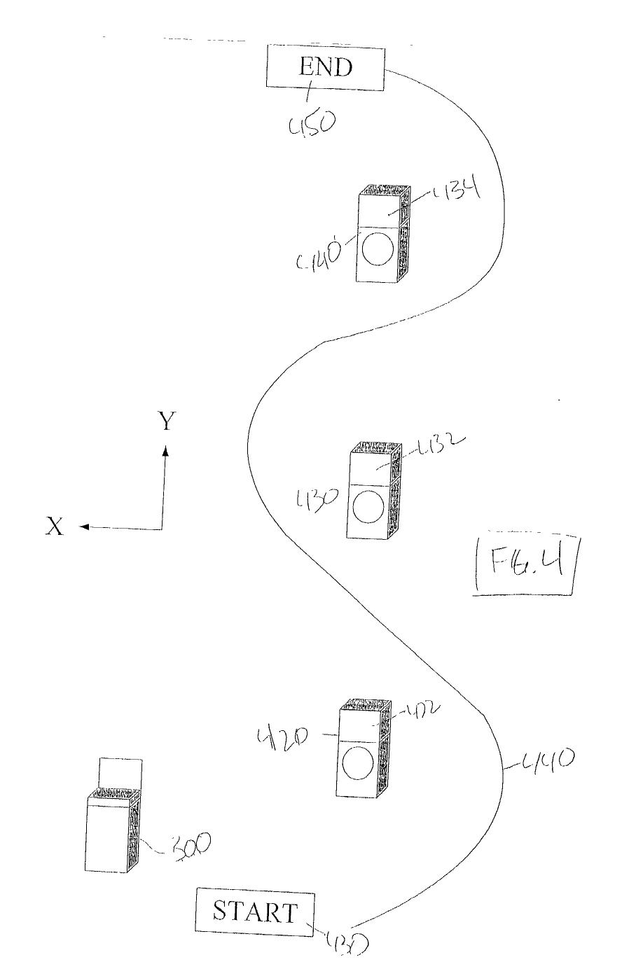

Referring now to FIG. 4, assume for example an athlete can comfortably dribble a soccer ball through an 80-meter serpentine weave course 440, i.e. a zigzag course, in 28 seconds. Serpentine weave course 440 includes system controller 300 (FIG. 3) and a plurality of data stations 100 (FIG. 1) which include first data station 420, second data station 430, and third data station 440.

Assuming such a workload represents 80% of maximum effort. After a suitable number of repetitions of this training regime, the athlete will stabilize at some comfort level with respect to speed, directional control, ball control, and coordination. Each of these performance criteria are important components contributing to the beauty of a masterful performance given by a skilled athlete.

For analysis purposes, assume such a stress index, i.e. successful performance of the afore-described serpentine weave dribbling routine in 28 seconds, comprises a quantitative level of 16 on a scale of 1 to 20. Assume further that on such a stress index scale, an incremental 1 second performance enhancement represents an additional 1 point on the 20 point scale. For analytical purposes, the athlete's effort and workload, as used here, are synonymous. As a general matter, Applicant has found that the more finely conditioned and skilled an athlete, the closer the effort and workload parameters will describe a linear function.

Applicant's apparatus, method, and performance enhancement management system, provides both an analytical, i.e. objective, tool for the coach, and a subjective, i.e. motivational, tool for the athlete. Using Applicant's apparatus, method, and performance enhancement management system, the coach can select the most efficacious incremental change in workload for the athlete. In addition, the athlete receives real-time incremental performance feedback to perform precisely at the specified workload rather than performing at a higher or lower stress index, i.e. perform faster or slower.

Referring again to FIG. 4, Applicant's invention allows the coach, or athlete for that matter, to adjust the timing at which visual display devices 422, 432, and 442, are energized by increments as small as 1/100th of a second. Such a small incremental time adjustment is well below the athlete's threshold of noticeable difference. Assume the coach determines the athlete should train 4% harder. The coach knows, for this athlete, an additional 20% of effort would represent that athlete's 100%, or maximum, performance capability.

The coach also knows that increasing the athlete's pace, i.e. work load, by one second, from 28 seconds to 27 seconds, will move the athlete up the stress scale, from 16 to 17. As those skilled in the art will appreciate, an increase in speed necessarily increases workload, lowers the total lapsed time, and increases stress. The objective for the coach is to maximize the benefit per training session. The objective for the athlete is maximize improvement with minimal stress. Applicant has found that athletes do accept, and will adapt readily to, small incremental changes in stress. The crucial issues then becomes: Just how small is small?

Using Applicant's apparatus, method, and performance enhancement management system, the answer to that question can be scientifically determined, can be precisely controlled, and can be repeated over and over again by the coach and athlete. For our subject soccer athlete, a one second change in workload, i.e. a performance enhancement to 27 seconds, over 80 meters is automatically divided by Applicant's invention computer into (N) equal parts, where (N) equals the number of data stations disposed along serpentine weave course 440.

For example, if course 440 includes nine (9) data stations, one second divided by 8 is ⅛ of a second or 0.125 milliseconds. Using Applicant's apparatus, method, and performance enhancement management system, the athlete is only required, and highly motivated, to arrive at each light station, a distance of only 10 meters, just 0.125 milliseconds faster. The athlete understands each time he “hits” a light station “on pace”, (from the audio and visual feedback), he can be confident he is precisely “on time” for a 27 second 80 meters. Applicant has found that motivation comprising such real time feedback can improve an athlete's performance dramatically.

In the event the athlete meets the incremental performance enhancement goal, both the athlete and the coach know the maximum “incremental” stress may have been about “1” on our scale of 20, all of which relates to the generation of, or more importantly, the nongeneration of lactic acid. The goal using Applicant's apparatus, method, and performance enhancement management system is to train the athlete right on the “edge” which represents that performance point comprising maximum stress level in combination with minimum generation of significant amounts of lactic acid. In other words, to maximally train aerobically rather than anaerobically.

Because Applicant's data station 100 is engineered for portability, and needs no external energy source, any number of data stations can be disposed using almost any sort of pattern. Referring again to FIG. 4, the disposition of data stations 420, 430, and 440 can be used for a sprint course where that course requires no motion in the X direction. On the other hand, the disposition of data stations shown in FIG. 4 can be used with the serpentine weave course 440 shown which requires some movement in the Y direction in combination with significant movement in the X direction.

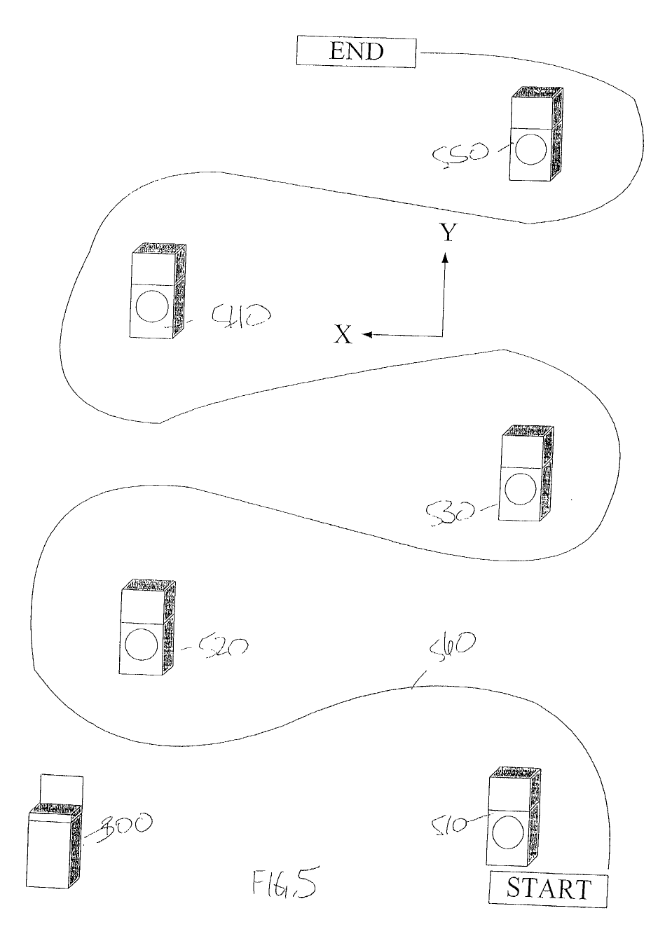

Referring now to FIG. 5, data stations 510, 520, 530, 540, and 550, define serpentine weave course 560 which requires movement in both the X direction and in the Y direction. As those skilled in the art will appreciate, courses 440 (FIG. 4) and 550 (FIG. 5) can be used in sports as diverse as track, football, soccer, field hockey, ice hockey, bicycling, and the like.

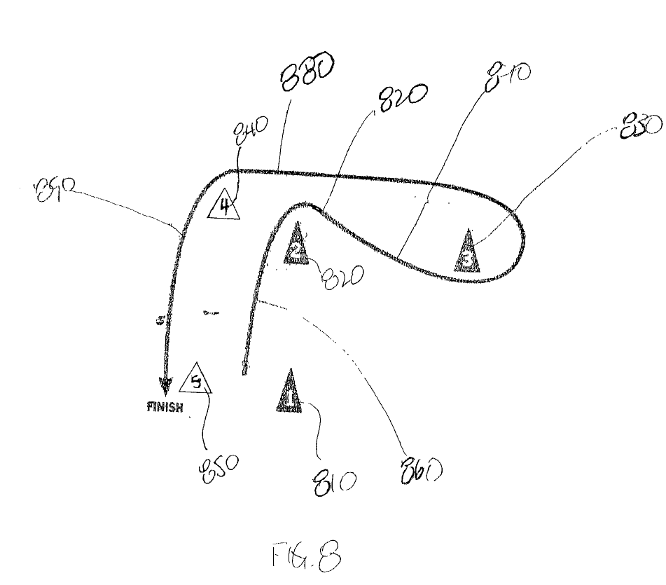

For example referring to FIG. 8, a course defined by data stations 810, 820, 830, 840, and 850, can include, for example, segments 860, 870, 880, and 890. Such a course is useful, for example, to train football, soccer, and/or field hockey players.

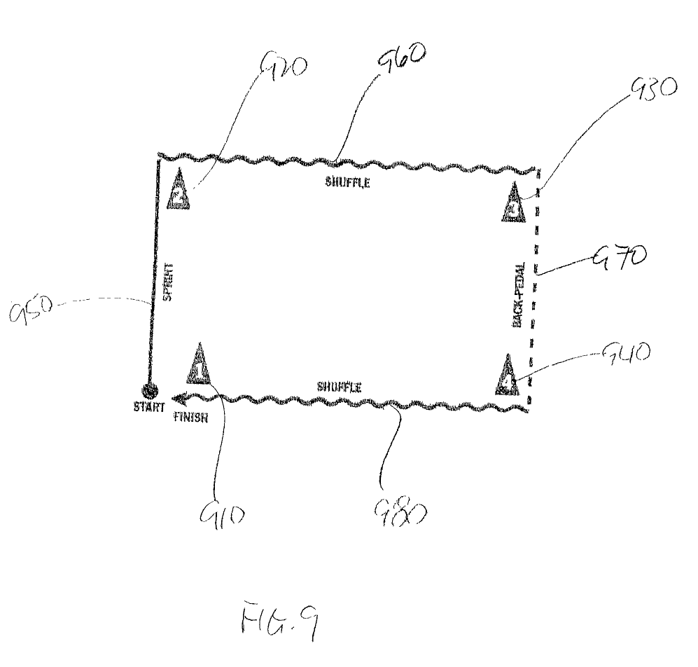

Referring now to FIG. 9. a course defined by data stations 910, 920, 930, and 940, can comprise segments 950, 960, 970, and 980. Differing training regimes, such as shuffle, back-pedal; and sprint, can be included. Such a course is useful, for example, to train football, soccer, and/or field hockey players.

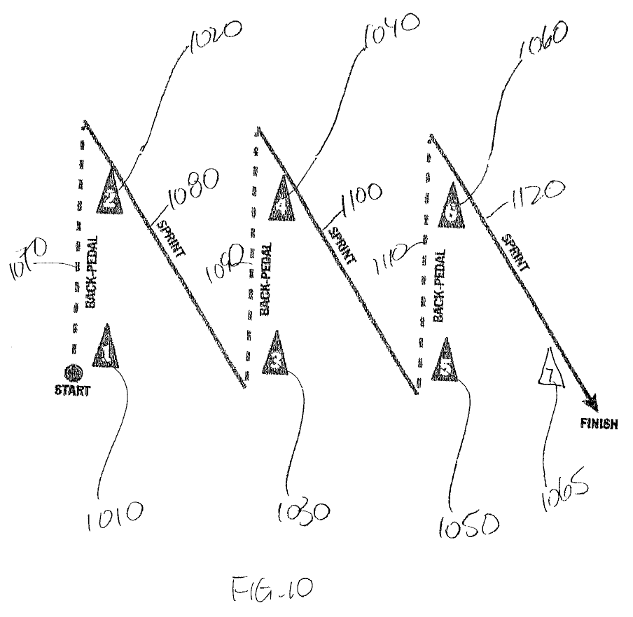

Referring to FIG. 10, a course defined by data stations 1010, 1020, 1030, 1040, 1050, 1060, and 1065, includes a combination of back-pedal segments 1070, 1090, 1110, interposed with sprint segments 1080, 1100, and 1120. Such a course is useful, for example, to train football, soccer, and/or field hockey players.

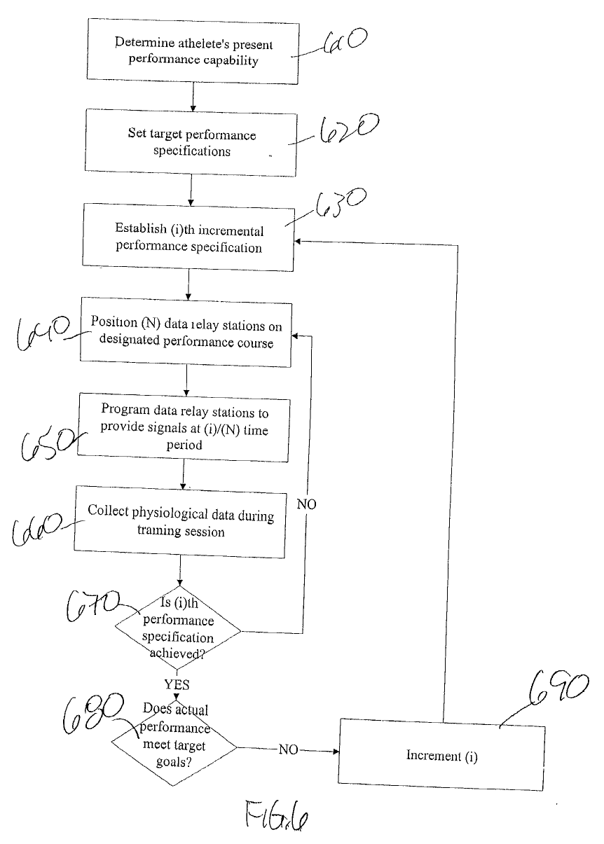

Applicants' method discussed below can be used in combination with any of the training courses discussed herein. The following example in conjunction with FIG. 6 illustrates one aspect of Applicant's invention. In this example, assume an athlete has a personal best (“PB”) time of ten (10) seconds for running a 100 meter course. The goal is to lower that time to 9.8 seconds. In step 610, the athlete's present performance capability is determined to be 10 seconds. In step 620, the ultimate performance target is determined to be 9.8 seconds.

If the coach feels this athlete is ready, in step 630 the coach establishes a first incremental performance specification of 9.90 seconds. In step 640, the coach places eleven (11) data stations equally along the 100 meter course. In step 650, Applicant's apparatus, method, and performance enhancement management system divides the one tenth second increase in speed by 10. This will lower the sequential “flash time” from 1.00 second to 0.99 seconds. This represents an increase in speed, i.e. stress, of only 0.01 seconds every 10 meters. The athlete knows each time he hits the light as it flashes, he is precisely on stride to complete this programmed 9.90 second workload.

In step 660, Applicant's apparatus, method, and performance enhancement management system collects real-time physiological data as the athlete runs the 100 meter course. This data is captured by one or more data stations and is then relayed to system controller 300.

In step 670, the coach determines if the first incremental performance enhancement has been achieved. In the event that first incremental performance enhancement has not been achieved, then Applicant's method transitions to step 640 and the athlete's training continues using this first incremental enhancement goal. On the other hand, in the event the coach determines in step 670 that the first incremental enhancement is met, then Applicant's method transitions to step 680 where the coach determines if the ultimate performance specification has been met.

In the event the ultimate performance goal has not yet been achieved, then Applicant's method transitions to step 630 where a second incremental performance goal is established. In this iterative fashion, Applicant's method gradually, scientifically, and predictably, advances the athlete's performance abilities in small, incremental steps until the final objective is met.

Applicant's apparatus, method, and performance enhancement management system is useful for athletes of all ability levels. Certain athletes are able to complete a 28 second 80 meter serpentine weave course at a stress level of say only 10, and elite athletes, perhaps much less. Because most football, basketball, soccer, and other such athletes should train at or near the same level as middle distance runners, Applicant's apparatus, method, and performance enhancement management system is useful to all these athletes.

Whatever conditioning level may apply for any individual athlete, the coach now has the “means” to select and control precise increments of change tailored to that athlete's needs and anticipated stress levels. In addition, the coach can automatically record and store one or more objective measures of those stress levels, including heart rate, blood pressure, respiratory rate, and the like. How many repetitions, over how many days, our soccer athlete will need to train at 27 seconds before the stress level begins to drop back down to 14, can be objectively determined from the athlete's heart rate.

As the stress level drops down, i.e. as the lactic acid threshold moves up, the coach can again increment the workload/speed and take the athlete back to a slightly higher stress level. This precise and measurable balance between workload/speed and stress is possible using Applicant's apparatus, method, and performance enhancement management system. The ability to directly measure, store, graph, and otherwise analyze real-time physiological parameters introduces an important innovation to coaching, an objective determination of aerobic conditioning progress.

The variables which can be precisely controlled and “coach/athlete” balanced, include: total distance, the interval distance, the flash time, the rest time, number of repeats and frequency of workouts. An athlete can achieve a “personal best” any time the coach wants that to happen considering speed increases can be as small as 0.01 divided by (N), where (N) is the total number of lights.

For an athlete's progress check, the coach can call up the “athlete's standard workload” (ASW). The coach will then set the system controller to record recovery heart rate, i.e. one reading every five seconds for three minutes immediately following the ASW. This data is automatically retained in the Athlete's data file, as “January 12 ASW-RC”, (recovery curve). One-month later, say on February 12, the coach may again want to measure training progress. The coach sets the data stations to energize at the ASW previously selected. Immediately after the athlete completes his “ASW”, his ending heart rate and recovery curve, are again automatically recorded for three minutes.

Using Applicant's apparatus, method, and performance enhancement management system, the “January 12 RC”, is plotted and then the current or, “February 12 RC”, is automatically plotted. The difference in the curves a direct measure of progress, or training effect, called “athletes training index” (ATI), is calculated and displayed. Needless to say, the coach hopes to see a positive difference between the two curves to indicate training is taking place. Very little difference in the curves means very little improvement has taken place. Worst yet, if “Feb 12 RC” plots higher than “Jan 12 RC”, detraining may actually have occurred. Once a coach becomes skilled using Applicant's apparatus, method, and performance enhancement management system, that coach can determine the optimal incremental changes to workload, and optimal frequency of implementing those changes

Another aspect of Applicant's apparatus, method, and performance enhancement management system includes using a multiple light system, red, blue, green, and yellow, and/or a multiple audible system, for example at each data station. Each of four runners, or soccer players, or other athletes, have their own assigned color/sound.

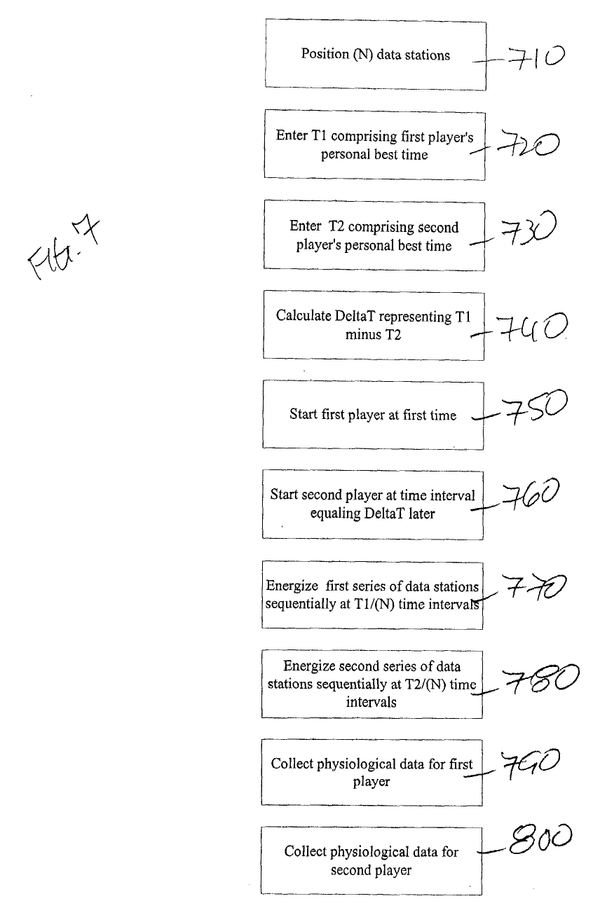

As an example, assume two athletes will compete using this aspect of Applicant's apparatus, method, and performance enhancement management system. Referring now to FIG. 7, in step 710 (N) data stations are positioned along a chosen course. In step 720, the personal best (“PB”) time T1 for the first player is entered into the system controller. In step 730, the PB time T2 for the second player is entered.

In step 740, a ΔT representing the time differential comprising the difference between T1 and T2 is calculated by the system controller. At the start command, the slower runner will automatically be given a start light first. In step 760 after a delay exactly equal to ΔT, the second athlete will automatically be given his start light at a second time comprising that time differential.

In accord with step 770, the first series of lights/sounds, i.e. a first color/first sound, is sequentially energized at T1/(N) time intervals. In accord with step 780, the second series of lights/sounds, i.e. a second color/second sound, is sequentially energized at T2/(N) time intervals. As both athletes advance on their own lights/sounds, at their respective paces, they will slowly converge until they approach the finish line. If they both run exactly their own PB they will cross the finish line together and it will be a “Tie”. Applicant has found, however, that the two athletes rarely each run exactly their PB. This aspect of Applicant's apparatus, method, and performance enhancement management system allows very unequal athletes to compete against one another. For example, a “weekend” athlete can competitively compete against a “world class” athlete.

Another embodiment of Applicant's invention includes use of a small signaling device, i.e. a radio frequency (“RF”) device which can be worn on the athlete. The signaling device can be detected by Applicant's data stations as the athlete passes. The RF device, which has the athletes' unique identification number, is used to record, store, and score “points” for that athlete. For example, if the athlete is right on pace at the moment the light flashes a point can be scored. Each time the athlete hits the next light on time (or on pace) his point score will build. However, if the athlete is early or late at the light station the “Time Target” will be missed and no point will be scored for that station. The degree of difficulty can be set using Applicant's apparatus, method, and performance enhancement management system described above.

An easy skill drill may have the “time window” set for a full second. A more difficult skill drill would be for example one half second, or for the really skilled athlete the time window may be in tenths of a second. After passing 8, or 16 of the lights (depending on the program set in the control means by the coach) the athlete may have a total score of say 8 or 16. The athlete's score can be printed out at the system controller, and can be used for individual athlete's evaluation, or for scoring the athlete based on the performance of this “Sporting Chance” drill.

Using Applicant's apparatus, method, and performance enhancement management system, world class soccer athletes may compete for score against less skilled soccer athletes. Boys and girls in grade school/middle school/high school physical education classes may simply enjoy testing their skills. Boys may compete against girls. Children may compete against their parents. The motivational aspects of Applicant's invention are evident.

Applicants' invention includes a system controller comprising a computer useable medium having computer readable program code disposed therein for implementing Applicants' method to enhance athletic performance. Applicants' invention further includes a data station controller comprising a computer useable medium having computer readable program code disposed therein for implementing Applicants' method to enhance athletic performance. Applicants' invention further includes computer program products embodied as program code stored in one or more storage device, such as a magnetic disk, a magnetic tape, or other non-volatile memory device disposed, for example, in a system controller and/or a data station controller.

I claim:

1. An athletic performance management system, comprising:
a system controller capable of wireless communication with each of one or more remote data stations;
(N) portable, hand-carryable, data stations capable of wireless communication with said controller, wherein each of said (N) data stations weighs less than about 1 kilogram;
a performance profile for an athlete stored in said controller, wherein said performance profile comprises the (i)th performance information for the (i)th data station, wherein (i) is greater than or equal to 1 and less than or equal to (N).

2. The system of claim 1, wherein said system controller is capable of providing first information to each of one or more data stations using a first frequency, and capable of receiving second information from each of one or more data stations using a second frequency, wherein said system controller provides the (i)th first information to the (i)th data station, wherein said first frequency is greater than about 1 gigahertz; and
wherein each of said (N) data stations is capable of receiving first information from said controller using said first frequency and capable of providing second information to said controller using a second frequency, wherein said second frequency is greater than about 1 gigahertz, and wherein the (i)th data station provides the (i)th second information to said system controller.

3. The system of claim 2, wherein each of said (N) data stations further comprises:
a housing;
an antenna internally disposed with said housing;
a transceiver disposed within said housing and interconnected with said antenna;
a data station controller interconnected with said transceiver;
a xenon strobe light disposed on the outer surface of said housing and interconnected with said data station controller; and
a fresnel lens covering said xenon strobe light.

4. The system of claim 3, wherein each of said (N) data stations further comprises an audio device.

5. The system of claim 4, further comprising:
a personal telemetry device capable of being worn by said athlete, wherein said personal telemetry device is capable of communicating with each of said (N) data stations.

6. A method to enhance athletic performance, comprising the steps of:
designating a performance course;
setting a target performance time for said athlete to negotiate said designated performance course;
ascertaining the (i)th actual performance time for said athlete to negotiate said designated performance course, wherein (i) initially is 1;
establishing the (i+1)th incremental performance time for said first person, wherein said (i+1)th incremental performance time is up to about one percent faster than the (i)th actual performance time;
providing (N) data stations comprising a xenon strobe light and an audio device, wherein each of said (N) data stations is capable of communicating with a system controller, wherein said system controller comprises a visual display device;
positioning (N) data stations along said designated performance course;
calculating, based upon said (i+1)th incremental performance time and the location of the (j)th data station along said designated performance course, the (j)th calculated time, wherein said (j)th calculated time comprises the time said athlete should pass the (j)th data station, wherein (j) is greater than or equal to 1 and less than or equal to (N);
negotiating said performance course by said first person beginning at a time t0;
flashing the xenon strobe disposed on the (j)th data station at a time equal to t0 plus said (j)th calculated time;
sounding the audio device disposed on the (j)th data station at a time equal to t0 plus said (j)th calculated time;
measuring the (j)th actual time, wherein said (j)th actual time comprises the time said athlete actually passes the (j)th data station;
displaying on said visual display device the difference between said (j)th calculated time and said (j)th actual time.

7. The method of claim 6, wherein said (N) data stations are not equally spaced along said designated performance course.

8. The method of claim 6, further comprising the steps of:
determining if the (N)th actual time is less than or equal to said (i+1)th incremental performance time, wherein the (N)th actual time comprises the time actually required by said athlete to negotiate said performance course;
operative if the (N)th actual time is greater than said (i+1)th incremental performance time, repeating said negotiating, flashing, measuring, displaying, and determining steps.

9. The method of claim 8, further comprising the steps of:
operative if the (N)th actual time is less than or equal to said (i+1)th incremental performance time, determining if the (N)th actual time is less than or equal to said target performance time;
operative if the (N)th actual time is less than or equal to said (i+1)th incremental performance time but greater than said target performance time:
setting (i) equal to (i+1);
setting said (N)th actual time equal to said (i)th actual time;
repeating said establishing, positioning, calculating, negotiating, flashing, measuring, displaying, and determining steps.

10. The method of claim 9, further comprising the step of locating said performance course on a soccer field, and wherein said negotiating comprises dribbling a soccer ball.

11. The method of claim 10, wherein said performance course comprises a serpentine weave.

12. The method of claim 9, further comprising the step of locating said performance course on a field hockey field, and wherein said negotiating comprises stick handling a field hockey ball.

13. The method of claim 12, wherein said performance course comprises a serpentine weave.

14. The method of claim 9, further comprising the step of locating said performance course on the ice portion of a hockey rink, and wherein said negotiating comprises stick handling a hockey puck.

15. The method of claim 14, wherein said performance course comprises a serpentine weave.

16. The method of claim 9, further comprising the step of locating said performance course on a lacrosse field, and wherein said negotiating comprises stick handling a lacrosse ball.

17. The method of claim 16, wherein said performance course comprises a serpentine weave.

18. The method of claim 9, further comprising the step of locating said performance course on running track, and wherein said negotiating comprises running in a forward direction.

19. The method of claim 18, wherein said negotiating comprises running in a backward direction.

20. The method of claim 9, further comprising the step of locating said performance course on football field, wherein said performance course comprises a serpentine weave, and wherein said negotiating comprises running in a forward direction.

21. The method of claim 9, further comprising the step of locating said performance course on football field, wherein said performance course comprises a serpentine weave, and wherein said negotiating comprises running in a backward direction.

22. A method to compare the athletic performances of a first person and a second person, comprising the steps of:
designating a performance course;
providing (N) first data stations, wherein each of said (N) first data stations comprises a first light emitting device and a first audio device;
positioning said (N) first data stations equidistant along said performance course;
providing (N) second data stations, wherein each of said (N) second data stations comprises a second light emitting device and a second audio device;
positioning said (N) second data stations equidistant along said performance course;
determining a time T1 comprising the fastest time a first person previously negotiated said designated performance course;
determining a time T2 comprising the fastest time a second person previously negotiated said performance course;
calculating a differential time comprising the difference between said time T1 and said time T2;
starting to negotiate said performance by said first person at a time t0;
starting to negotiate said performance course by said second person at a time t0 plus said differential time;
flashing each of said (N) first light emitting devices, and sounding each of said first audio devices, sequentially at T1/(N) time intervals;
flashing each of said (N) second light emitting devices, and sounding each of said second audio devices, sequentially at T2/(N) time intervals.

23. The method of claim 22, wherein each of said first light emitting device comprises a first color, and wherein each of said second light emitting device comprises a second color.

24. The method of claim 22, wherein each of said first audio devices emits a first sound and wherein each of said second audio devices emits a second sound.
